(19) United States
(12) Patent Application Publication
(10) Pub. No.: US 2010/0044986 A1
(43) Pub. Date: Feb. 25, 2010

(54) RIDING PLATFORM WITH ROTATING DECK

(76) Inventor: Jeff Dannenberg, Fort Lauderdale, FL (US)

Correspondence Address: MALIN HALEY DIMAGGIO BOWEN & LHOTA, P.A., 1936 S ANDREWS AVENUE, FORT LAUDERDALE, FL, 33316, US

(21) Appl. No.: 12/545,307

(22) Filed: Aug. 21, 2009

Related U.S. Application Data
(60) Provisional application No. 61/090,926, filed on Aug. 22, 2008.

(51) Int. Cl. B62M 1/00

(52) U.S. Cl. 280/87.042

(57) ABSTRACT

A skateboard is adapted to include an auxiliary rotating platform which swivels upon a flat plate device secured to the upper surface of the board. An auxiliary platform is rotatably affixed to the top surface of the deck by a swivel mechanism that allows for full 360° rotation in both clockwise and counterclockwise directions. The auxiliary platform is preferably connected to upper deck surface by a flat bar stool type swivel mechanism having rotatably connected upper and lower plates separated by ball bearings. The auxiliary platform provides a structure capable of supporting the weight of the user while allowing the user to rotate about the swivel axis.

### CROSS REFERENCE TO RELATED APPLICATIONS

This application claims the benefit of provisional U.S. Patent Application Ser. No. 61/090,926, filed on Aug. 22, 2008.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

The present invention relates to a recreational riding apparatus, and more particularly to a rotating deck apparatus for use in connection with a riding platform, such as a skateboard to provide an additional degree of freedom of motion for the rider thereby enhancing thrills and allowing for more complex tricks and riding styles.

2. Description of Related Art

A recreational riding platform, also frequently called a skateboard, is an apparatus which utilizes four wheels and a board or deck. To propel the skateboard on a level surface the user typically stands upon the deck and propels the body by pushing off the ground with one foot while maintaining upright body posture with the foot remaining on deck. The typical skateboard wheel assembly includes two trucks and four wheels. The trucks are each fixed to the underside of the deck by a baseplate anchored by fasteners. Each track includes an axle having wheels connected at opposing ends.

The ancestors of the modern skateboard date back to the 1930's, where the first boards supported the undercarriage of children's soapbox cars. It is believed that as the soapbox portion of the car fell apart, children continued to use the undercarriage, formed of wooden planks and roller skate wheels. Such a riding device was referred to as a skateplank. As such devices became more popular, surfers began using the skateplanks to recreate the feel of surfing on land. First mass-produced in the 1960's, skateboards have evolved with enhanced decks, rather than the flat planks of wood first used. Today, skateboards can be custom built, with various size and shape decks available.

Variations in the deck shape and size influence the user's experience. Typically made of Canadian maple wood, other materials such as plastic, fiberglass, bamboo, or aluminum each contribute alternative characteristics which can affect the riding experience. The width of the deck can commonly vary between seven to ten and one-half inches, while the length of a standard size board is between 28 and 33 inches long. Longboards, an alternate variety of skateboard, are available in lengths between 35 and 60 inches; this variety is popular for characteristics similar to surfing, but is not often used for skateboarding tricks. Most decks have curvature of some sort. Such contoured shape allows for enhanced maneuverability. ‘Camber’ is when the center of the board is curved upwards (when viewed from the side); this provides a bouncier feeling while riding. For a rocking sensation, some boards are curved downwards (when viewed from the side); this characteristic is called ‘rocker’. Other boards have upward-curved edges, providing a concave riding surface, allowing for stiffness and leverage. Additionally, an upward bend of the nose or tail allows for enhanced trick capability.

While skateboards have been used in performing spectacular tricks and stunts movement of the user relative to the board is limited by conventional board designs. Limitations in the present art exist in that the user is restricted to utilizing a stationary board surface for riding in a forward or backward direction, which significantly limits the user's range of motion and ability to complete tricks.

As a result of the limitations and disadvantages present with the use of a conventional skateboard, the background art reveals a number of attempts directed to providing improvements in the art of riding platforms. For example, U.S. Pat. No. 3,399,904 issued to Schinke, reveals a skate board structure with several sets of swivel wheels and a tiltable upper plate for enhancing the turning radius while riding. Additionally, U.S. Pat. No. 3,339,939 issued to Bowers, discloses a toy vehicle for children with a plurality of caster wheels attached directly to the underbelly of a circular base. The wheels are spaced apart so that the device can twirl, move, or spin about in any direction.

The references of the background art are primarily designed to enhance the riding experience. Limitations in the current art are revealed in the riding direction, as being restricted to a general forward or backward motion. This limitation has resulted in the commercial success and widespread use of such devices. Accordingly, there remains a need in the art for further innovation and improvement that allow for more spectacular and complex riding, tricks, and stunts.

### BRIEF SUMMARY OF THE INVENTION

The present invention overcomes the limitations and disadvantages present in the art by adapting a conventional skateboard to include an auxiliary rotating platform which swivels upon a flat plate device secured to the upper surface of the board. An auxiliary platform is rotatably affixed to the top surface of the deck by a swivel mechanism that allows for full 360° rotation in both clockwise and counterclockwise directions. In accordance with a preferred embodiment intended for use with a conventional elongate deck, the auxiliary platform is circular in shape and generally centered on the deck. The auxiliary platform preferably has a diameter that is sufficiently less than the length of the skateboard deck so as to provide space on either side thereof for the user's feet. The auxiliary platform is preferably connected to upper deck surface by a flat bar stool type swivel mechanism having rotatably connected upper and lower plates separated by ball bearings. The auxiliary platform provides a structure capable of supporting the weight of the user while allowing the user to rotate about the swivel axis.

Accordingly, it is an object of the present invention to provide advancements in the field of skateboards.

Another object of the present invention is to provide a skateboard adapted with an auxiliary platform connected thereto by a swivel mechanism.

These and other objects are met by the present invention which will become more apparent from the accompanying drawing and the following detailed description of the drawings and preferred embodiments.

### BRIEF DESCRIPTION OF THE SEVERAL VIEWS OF THE DRAWINGS

FIG. 1 is a top perspective view of a skateboard adapted with an auxiliary swivel platform in accordance with the present invention;

FIG. 2 is a side view thereof;

FIG. 3 is an exploded top perspective view thereof;

FIG. 4 is a top perspective view of an alternated embodiment circular skateboard adapted with a similarly sized auxiliary swivel platform in accordance with the present invention;

FIG. 5 is a side view thereof;

FIG. 6 is an exploded top perspective view thereof;

FIG. 7 is a top perspective view of an alternate embodiment skateboard wherein the swivel platform is mounted on the underside of the skateboard;

FIG. 8 is a side view thereof, and

FIG. 9 is a top exploded view thereof.

### DETAILED DESCRIPTION OF THE INVENTION

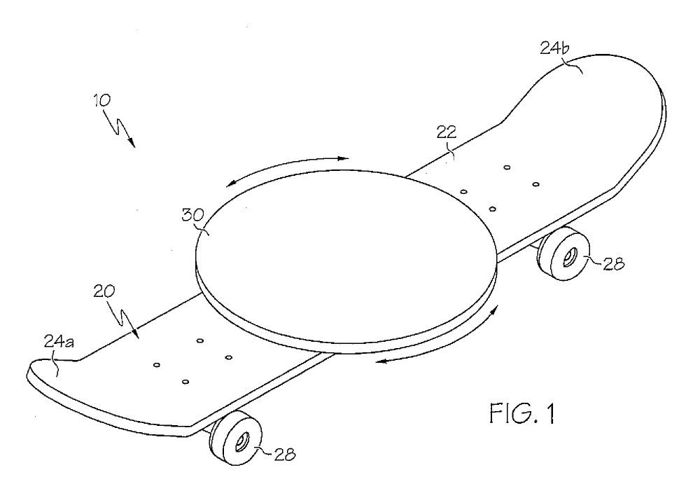

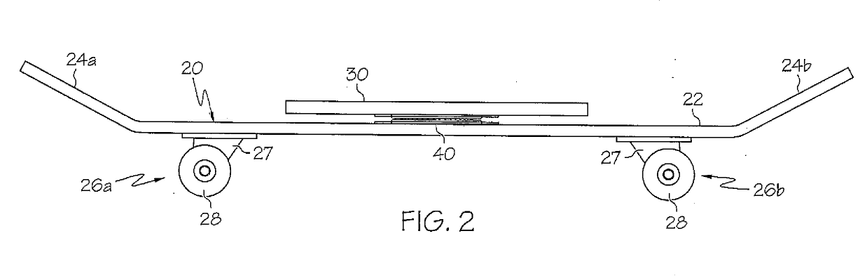

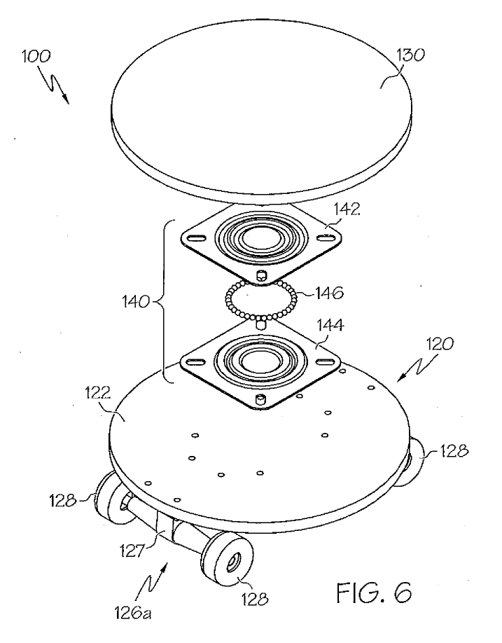

With reference now to the drawings, FIGS. 1-9 depict preferred and alternate embodiments of the present invention. Turning first to FIGS. 1-3 there is depicted a preferred embodiment of the present invention, generally referenced as 10, comprising a skateboard-type riding platform 20 adapted to include an auxiliary rotating platform 30 which swivels upon a flat plate device, generally referenced as 40, secured to the upper surface of the skateboard. Skateboard 20 includes a board or deck 22 that may include upwardly angled ends, referenced as 24a and 24b. Attached to the bottom of deck 22 are two wheel assemblies, referenced as 26a and 26b. Each wheel assembly includes a truck 27 having an axle to which wheels 28 are rotatably connected. Skateboard 20, trucks 27 and wheels 28 may be conventional in accordance with the current state of the art for skateboards. In an alternate embodiment, the conventional skateboard wheels and trucks may be replaced with ball casters.

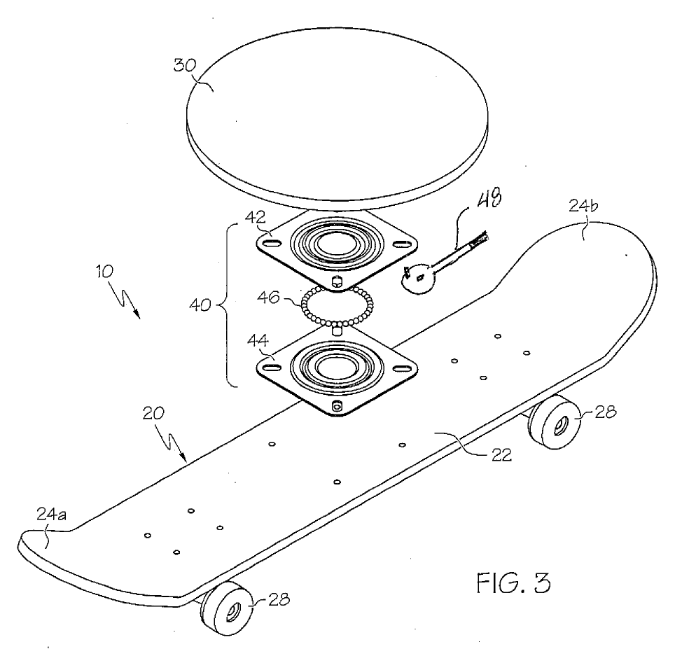

As best depicted in FIG. 3, a significant aspect of the present invention includes providing an auxiliary platform 30 that is rotatably affixed to the top surface of skateboard deck 20, positioned between ends 24a and 24b, by a swivel mechanism 30 that allows for fill 360° rotation in both clockwise and counterclockwise directions. In accordance with a preferred embodiment, auxiliary platform 30 comprises a generally planar platform having a generally circular shape when viewed from above, and a diameter that is sufficiently less than the length of the skateboard deck so as to provide space on either side thereof for the user's feet, but greater than the width of the skateboard to provide sufficient room for both of the rider's feet. As further illustrated in FIG. 3, auxiliary deck 30 is preferably connected to top surface of deck 20 by a flat bar stool type swivel mechanism, generally referenced as 40. Swivel mechanism 40 includes rotatably connected upper and lower plates, referenced as 42 and 44 respectively, adapted for 360 degree rotation. As should be apparent, upper plate 42 is fastened to the bottom surface of auxiliary deck 30, and lower plate 44 is fastened to the top surface of deck 20. Upper and lower plates 42 and 44 each define a raceway for receiving ball bearings 46 sandwiched therebetween to facilitate generally free rotation of one plate relative to one another. The auxiliary platform 30 provides a structure capable of supporting the weight of the user while allowing the user to rotate about the swivel axis. In a preferred embodiment, swivel 40 allows for 360 degree rotation. In an alternate embodiment, swivel 40 is configured to allow for less than 360 degree rotation. More particularly, the present invention contemplates swivel mechanism 40 adapted to allow for manual adjustment to allow the user to set the desired degree of rotation from 0-360 degrees. In accordance with this embodiment, swivel mechanism includes a lever 48 that is movable in increments between a minimum rotation position wherein relative movement between upper and lower plates 42 and 44 is prevented (e.g. fixed) and a maximum rotation position wherein the upper and lower plates are capable of free rotation. Lever 48 may be adjusted to intermediate positions wherein desired degrees of rotation are permitted (e.g. 30°, 60°, 90°, 180°, 270° etc.). In addition, the direction of rotation may be clockwise, counter-clockwise, or both. Finally, swivel 40 may include a locking mechanism to allow the auxiliary deck to be selectively fixed.

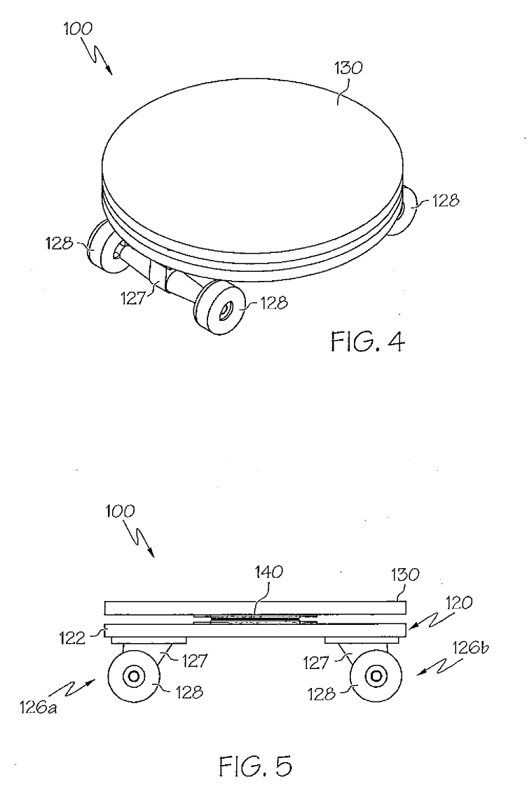

FIGS. 4-6 depict an alternate embodiment skateboard, generally referenced as 100, in accordance with the present invention. Skateboard 100, comprise a skateboard 120 adapted to include an auxiliary rotating platform 130 which swivels upon a flat plate device, generally referenced as 140, secured to the upper surface of the skateboard. Skateboard 120 includes a generally circular deck 122. Attached to the bottom of deck 122 are two wheel assemblies, referenced as 126a and 126b. Each wheel assembly includes a truck 127 having a transverse axle to which wheels 128 are rotatably connected. Skateboard 120, trucks 127 and wheels 128 may be conventional in accordance with the current state of the art for skateboards.

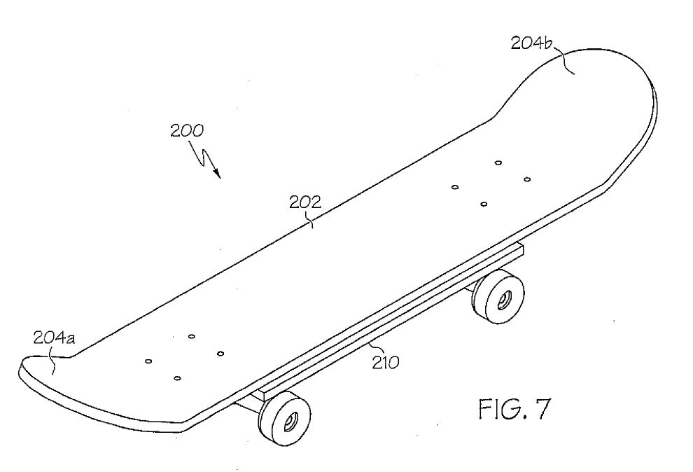

As best depicted in FIG. 6, a significant aspect of the present invention includes providing an auxiliary platform 130, that is similar in size to circular deck 122, and is rotatably affixed to the top surface of skateboard deck 122, by a swivel mechanism 130 that allows for fill 360° rotation in both clockwise and counterclockwise directions. In accordance with this alternate embodiment, auxiliary platform 130 comprises a generally planar platform having a generally circular shape when viewed from above, and a diameter that is approximately equal to the diameter of circular skateboard deck 122. As further illustrated in FIG. 6, auxiliary deck 130 is preferably connected to top surface of deck 120 by a flat bar stool type swivel mechanism, generally referenced as 140. Swivel mechanism 140 includes rotatably connected upper and lower plates, referenced as 142 and 144 respectively. As should be apparent, upper plate 142 is fastened to the bottom surface of auxiliary deck 130, and lower plate 144 is fastened to the top surface of deck 122. Upper and lower plates 142 and 144 each define a raceway for receiving ball bearings 146 sandwiched therebetween to facilitate generally free rotation of one plate relative to one another. The auxiliary platform 130 provides a structure capable of supporting the weight of the user while allowing the user to rotate about the swivel axis.

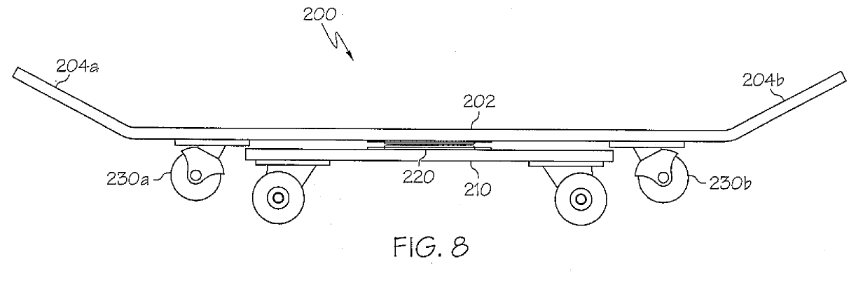

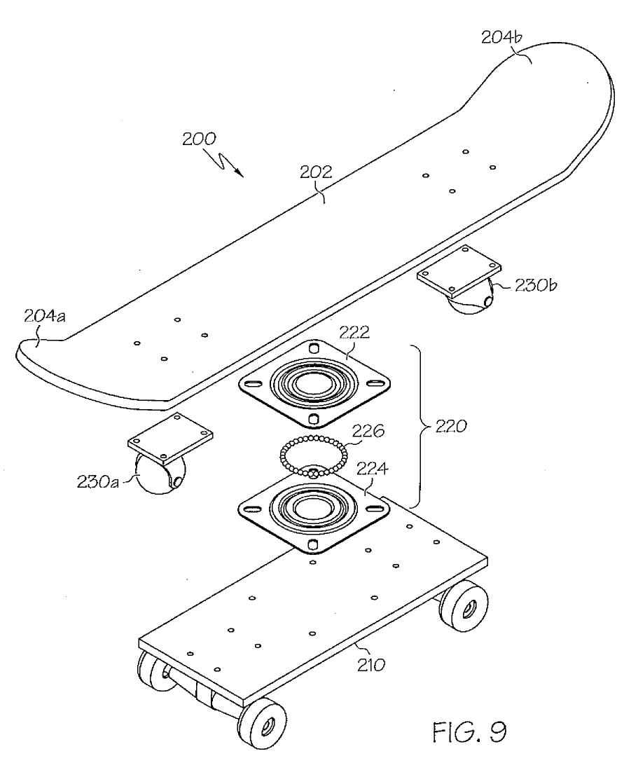

FIGS. 7-9 depict yet another alternate embodiment skateboard, generally referenced as 200, in accordance with the present invention. Skateboard 200 includes a conventional skateboard deck 202 having upwardly angled ends 204a and 204b. Skateboard deck 202 is mounted to a lower elongate rigid board, referenced as 210, that is smaller in length than deck 202. Skateboard deck 202 is rotatably affixed to the top surface of rigid board 210, by a swivel mechanism 220 that allows for full 360° rotation in both clockwise and counterclockwise directions. In accordance with this alternate embodiment, rigid board 210 comprises a generally planar platform having a length that is less than the length of skateboard deck 202. As further illustrated in FIG. 9, skateboard deck 202 is preferably connected to top surface of rigid board 210 by a flat bar stool type swivel mechanism, generally referenced as 220. Swivel mechanism 220 includes rotatably connected upper and lower plates, referenced as 222 and 224 respectively. As should be apparent, upper plate 222 is fastened to the bottom surface of skateboard deck 202, and lower plate 224 is fastened to the top surface of rigid board 210. Upper and lower plates 222 and 224 each define a raceway for receiving ball bearings 226 sandwiched therebetween to facilitate generally free rotation of one plate relative to one another. The skateboard deck 202 provides a structure capable of supporting the weight of the user while allowing the user to rotate about the swivel axis. In addition, skateboard deck 202 includes ball casters, generally referenced as 230a and 230b, mounted to the bottom surface thereof in spaced relation with the opposing ends of rigid board 210 as best seen in FIG. 8. Ball casters 230a and 230b are intended to engage the ground only in situations wherein skateboard deck 202 becomes angularly disposed (e.g. tips) relative to horizontal.

The instant invention has been shown and described herein in what is considered to be the most practical and preferred embodiment. It is recognized, however, that departures may be made therefrom within the scope of the invention and that obvious modifications will occur to a person skilled in the art.

What I claim is:

1. A skateboard-type riding platform comprising:
a board having a top surface, a bottom surface, a front end, a rear end, and a middle disposed between said front and rear ends, and a length, and a width;
a first wheel assembly attached to the bottom surface of said board in proximity to said front end, and a second wheel assembly attached to the bottom surface of said board in proximity to said rear end, each wheel assembly including a transverse axle and a pair of wheels journaled to opposing ends of said axle;
an auxiliary deck having a bottom pivotally connected to the middle of the top surface of said board by a swivel mechanism such that said auxiliary deck is freely rotatable about a generally vertical pivot axis.

2. A skateboard-type riding platform according to claim 1, wherein said auxiliary deck is generally circular.

3. A skateboard-type riding platform according to claim 2, wherein said circular auxiliary deck has a diameter that is greater than the width of said board.

4. A skateboard-type riding platform according to claim 1, wherein said auxiliary deck comprises an elongate structure having a length greater than the length of said board, and a width approximately equal to the width of said board.

5. A skateboard-type riding platform according to claim 4, further including a first ball caster connected to the bottom of said auxiliary deck in proximity to a first end thereof, and a second ball caster connected to the bottom of said auxiliary deck in proximity to a second end thereof to engage the ground in situations wherein said auxiliary deck becomes angularly disposed relative to a horizontal plane.
